(19) United States
(12) Patent Application Publication
(10) Pub. No.: US 2012/0194376 A1
(43) Pub. Date: Aug. 2, 2012

(54) Millimeter Wave Energy Sensing Wand and Method

(75) Inventor: Robert Patrick Daly, Orlando, FL (US)

(73) Assignee: Brijot Imaging Systems, Inc.

(21) Appl. No.: 13/019,722

(22) Filed: Feb. 2, 2011

(51) Int. Cl. G01S 13/88

(52) U.S. Cl. 342/22

(57) ABSTRACT

A millimeter wave energy sensing wand is disclosed. In a particular embodiment, the wand includes a housing adapted to be grasped by a hand of an operator, at least one pixel contained within the housing, where the at least one pixel adapted to detect millimeter or terahertz wave energy emissions, and an alarm, where the alarm is activated when an anomaly of the millimeter wave energy emissions is detected. In addition, the wand may include a digital signal processor for processing millimeter wave emissions detected by the at least one pixel to determine millimeter wave energy values and a memory device for storing the millimeter wave energy values. A comparison module or other similar means may be used for comparing the millimeter wave energy values detected by the at least one pixel to a background millimeter wave energy value that may be a moving average or an absolute value.

### I. FIELD

The present invention relates in general to the field of concealed object detection systems using millimeter wave energy, and in particular to a handheld millimeter wave energy sensing wand and method.

### II. DESCRIPTION OF RELATED ART

A passive millimeter wave camera has the ability to detect and image objects hidden under clothing using millimeter wave imagery. The passive millimeter wave (PMMW) sensors detects radiation that is given off by all objects. The technology works by contrasting the millimeter wave signature of the human body, which is warm and reflective, against that of a gun, knife or other contraband. Those objects appear darker or lighter because of the differences in temperature, hence, millimeter wave energy, between the human body and the inanimate objects.

While the expanded use of whole body imaging (WBI) systems provides increased security at airports, it creates a problem for secondary screening, since metal detector wands will not be able to detect non-metallic objects found by the WBI systems. Therefore, time-consuming and invasive physical pat downs will be required, and/or the subject can be iteratively sent back through the WBI to clear alarms. Either approach will necessarily slow throughput at security checkpoints, which would have negative economic and security implications. Hence, a need exists in the art for a device and method that implements PMMW sensor technology into an ergonomic, hand-held wand to provide a powerful solution for secondary screening and alarm clearance.

Ideally, a secondary screening sensor would be matched to a primary screening sensor technology, however, the deployment of X-ray backscatter and/or an active millimeter wave (MMW) imaging systems makes this problematic. A handheld X-ray wand is not practical due to size, weight and power (SWAP) considerations. An active MMW radar wand can be developed and deployed, but body contours will present challenges for detection and false alarms due to unpredictable scattering. In addition, impractical scan times for an active radar will likely result from attempts to address these detection and false alarm issues. Furthermore, relying on an image-based sensor for secondary screening, which may help alleviate the aforementioned false alarms, would exacerbate privacy concerns and may prevent thorough screening over all parts of the body. Accordingly, a need exists in the art for a device and method that can meet performance, SWAP and operational requirements, while completely avoiding any radiation or privacy concerns.

Harsh and uncontrolled environments can affect the operation of prior art WBI systems that must be adapted for each installation to provide the proper contrast between the environment and a subject so that the PMMW sensors can detect concealed objects, which is expensive and time consuming Further, personnel must be trained to operate the system for each different installation environment. Hence, a need exists in the art for a system for a millimeter wave energy sensing wand that simplifies training and ease of use. A need also exists in the art for a millimeter wave energy sensing wand that eliminates the need to custom engineer the device to an uncontrolled environment.

Another shortcoming is that the prior art WBI systems are dependent on existing utilities and on-site support, which is not always available in a harsh environment. Accordingly, what is needed is a millimeter wave energy sensing wand that eliminates the need for services such as air conditioning and an external power source to operate.

However, in view of the prior art at the time the present invention was made, it was not obvious to those of ordinary skill in the pertinent art how the identified needs could be fulfilled.

### III. SUMMARY

In a particular embodiment, a millimeter wave energy sensing wand is disclosed. The millimeter wave energy sensing wand includes a housing adapted to be grasped by a hand of an operator, at least one pixel contained within the housing, where the at least one pixel adapted to detect millimeter wave energy emissions, and an alarm, where the alarm is activated when an anomaly of the millimeter wave energy emissions is detected. A lens may be mounted within the housing and configured to focus the millimeter wave energy to the at least one pixel. A power source such as an on-board battery may power the wand or the wand may be powered by connecting to standard 110V or 220V outlet. The wand may also include a proximity sensor to determine when the at least one pixel is positioned correctly over a body. In addition, the wand may include light emitting diodes (LEDs) to visually illuminate a scan area on a body. A vibration motor may be activated by the alarm, where the vibration motor provides vibrations to a handle portion of the housing. Further, the wand may include a digital signal processor for processing millimeter wave emissions detected by the at least one pixel to determine millimeter wave energy values and a memory device for storing the millimeter wave energy values. A comparison module or other similar means may be used for comparing the millimeter wave energy values detected by the at least one pixel to a background millimeter wave energy value, where the background value may be a moving average value or an absolute value.

In another particular embodiment, a millimeter wave energy sensing method is disclosed. The method includes determining a background value of millimeter wave energy emissions of a body that may be a moving average value or an absolute value, moving a millimeter wave energy sensing wand in proximity over the body, detecting an anomaly between the background value and the millimeter wave energy emissions at discrete locations on the body, and activating an alarm when the anomaly of the millimeter wave energy emissions is detected. The method also includes determining when the millimeter wave sensing wand is proximate to the body and vibrating the millimeter sensing wand when activating the alarm. In addition, the method includes focusing millimeter wave energy emissions to at least one pixel of the millimeter wave energy sensing wand.

One particular advantage provided by embodiments of the millimeter wave energy sensing wand is the highly portable design and construction. Another particular advantage provided by embodiments of the wand is that the need for a controlled environment is eliminated. In addition, the system can operate for weapons detection and for theft prevention.

The millimeter wave energy sensing wand does not rely on imaging of a body but on receiving naturally occurring millimeter wave energy emissions from the human body. Accordingly, invasion of privacy concerns are eliminated and thorough screening over all parts of the body can be accomplished.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a front perspective view of a particular embodiment of the millimeter wave energy sensing wand;

FIG. 2 is a rear perspective view of the particular embodiment of the millimeter wave energy sensing wand of FIG. 1;

FIG. 3 is a front perspective view of the particular embodiment of the millimeter wave energy sensing wand of FIGS. 1 and 2 shown without the housing;

FIG. 4 is a side perspective view of the particular embodiment of the millimeter wave energy sensing wand of FIGS. 1 and 2 shown without the housing;

FIG. 5 is a perspective view of the scanning area of the particular embodiment of the millimeter wave energy sensing wand of FIGS. 1-4;

FIG. 6 is diagram of scanning a body with the particular illustrative embodiment of the millimeter wave energy sensing wand of FIGS. 1-5;

FIG. 7 is a rear perspective view of another particular embodiment of a millimeter wave energy sensing wand;

FIG. 8 is a front perspective view of the particular embodiment of the millimeter wave energy sensing wand of FIG. 7;

FIG. 9 is a bottom perspective view of the particular embodiment of the millimeter wave energy sensing wand of FIGS. 7 and 8 shown without the housing;

FIG. 10 is a top perspective view of the particular embodiment of the millimeter wave energy sensing wand of FIGS. 7 and 8 shown without the housing;

FIG. 11 is a perspective view of the of the millimeter wave energy sensing wand of FIGS. 7-10 and illustrating a boundary of the associated scanning area;

FIG. 12 is a perspective view of the millimeter wave energy sensing wand of FIGS. 7-11 illustrating a boundary of the associated scanning area;

FIG. 13 is diagram of scanning a body with the particular illustrative embodiment of the millimeter wave energy sensing wand of FIGS. 7-12;

FIG. 14 is an elevational view of another particular embodiment of a millimeter wave energy sensing wand;

FIG. 15 is a rear perspective view of the particular embodiment of the millimeter wave energy sensing wand of FIG. 14;

FIG. 16 is a bottom perspective view of the particular embodiment of the millimeter wave energy sensing wand of FIGS. 14 and 15;

FIG. 17 is a top perspective view of the particular embodiment of the millimeter wave energy sensing wand of FIGS. 14-16;

FIG. 18 is a perspective shadow view of the of the millimeter wave energy sensing wand of FIGS. 14-17 and illustrating a configuration of internal components;

FIG. 19 is a perspective view of the of the millimeter wave energy sensing wand of FIGS. 14-18 and illustrating a boundary of the associated scanning area;

FIG. 20 is a diagram of scanning a body with the particular illustrative embodiment of the millimeter wave energy sensing wand of FIGS. 14-19; and

FIG. 21 is a flow diagram of a particular embodiment of a millimeter wave energy sensing method.

### V. DETAILED DESCRIPTION

The millimeter wave energy sensing wand provides the same throughput as a current metal detector (MD) wand approach, while enabling reliable detection of both non-metallic and metallic objects. Like the MD wand, the millimeter wave energy sensing wand will audibly alert the operator to concealed objects in real time. The millimeter wave energy sensing wand will not produce any imagery and can therefore be used over the entire body without causing any privacy concerns. High-probability detection is achievable over all parts of the body at a scan rate of ˜1 m/s. Minimal training is required because operation is similar to the current MD wand procedure. The millimeter wave energy sensing wand may weigh <2 lbs and operate on standard battery power for at least one full day before requiring a recharge. The wand may also be combined with any metal detector components and technology to provide additional efficacy in detecting metallic and non-metallic objects.

The millimeter wave energy sensing wand penetrates clothing to detect concealed objects, including plastics, metal, bulk explosives, liquids and gels. PMMW algorithms look for contrast anomalies between the background (human body) and concealed objects hidden under clothing. The human body naturally emits energy in the MMW band, and concealed objects block these emissions, producing a readily-detectable contrast when the body is scanned. The PMMW sensors (or pixels) of the millimeter wave energy sensing wand do not provide the same image resolution as X-rays or active MMW radars, but there is no radiation threat, either for passengers or operators, and privacy issues are not a concern.

Because the underlying detection phenomenology relies on receiving naturally-occurring MMW energy emissions from the human body (i.e., energy which would be blocked by concealed objects) rather than reflection of transmitted energy off concealed objects, which must be distinguished from complex reflections off the body, the detection algorithms of the PMMW energy sensing wand operate on much more stable and predictable data. This produces more consistent object detection performance over all body contours with a much lower false alarm rate.

A range measurement device (e.g., proximity sensor) may be used at each pixel to ensure that only measurements from the body are received because elements not positioned directly over the body could receive extraneous energy that would confuse the detection algorithm, or these pixels could register low emissions which may be confused with object blockage. The proximity sensor will ensure that pixels not positioned over the body are not included in the detection process. The proximity sensor may be an infrared sensor, for example. In addition, a scanning speed sensor may be included to check the speed at which the wand is being used to scan a body. A three-axis accelerometer may be used to determine an estimate of the scanning speed to convert to a frequency to filter the output. For example, if the scanning speed is determined to be 20 Hz, then any 20 Hz (+−) changes are filtered out due to the scanning speed and not a concealed object.

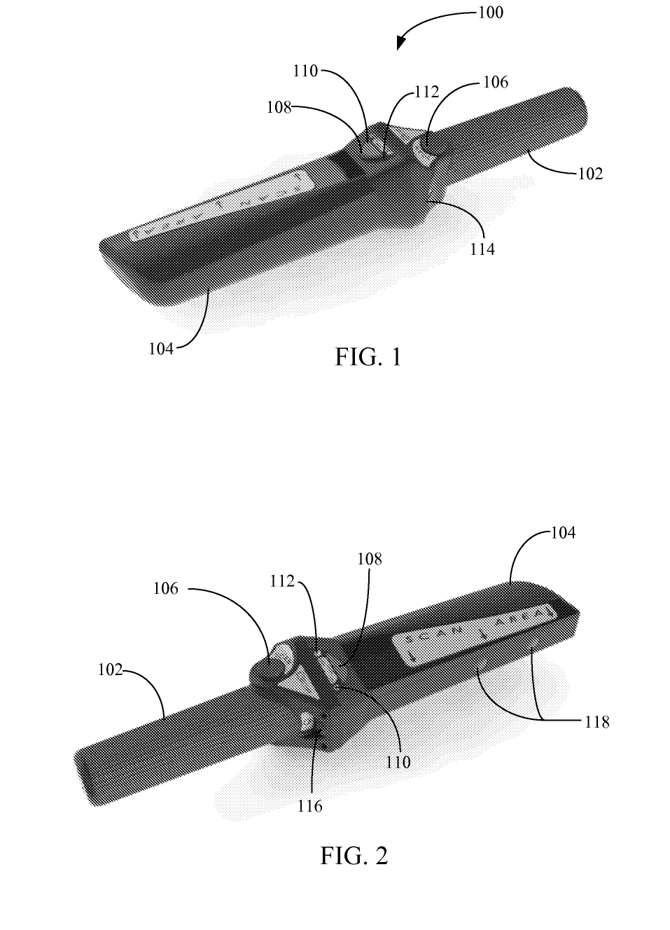

Referring now to FIGS. 1 and 2, a particular illustrative embodiment of a millimeter wave energy sensing wand is disclosed and generally designated 100. The wand includes a housing 104. The housing 104 is used to contain at least one pixel and other electronics for detecting and processing millimeter wave energy including energy above and below millimeter wave (e.g., terahertz). Accordingly, wherever the term “millimeter wave” is used herein, it is also intended to include electromagnetic waves propagating at different frequencies such as at least terahertz wave as well, and not limited to millimeter wave. For example, the pixel(s) are adapted to detect millimeter wave energy emissions and/or terahertz emissions. A handle 102 allows an operator to grasp the wand 100 and orient the wand 100 appropriately as it is passed over a body during scanning. A scan button 106 is pressed by the operator to activate the wand 100 and to begin receiving millimeter wave energy to determine whether a concealed object may be present on the body. An alarm is activated when an anomaly of the millimeter wave energy emissions is detected. A visual alarm light 108 (e.g., LED) may be illuminated when the alarm is triggered. A power or “on” light 110 is disposed on the housing 104 to signal to the operator that the wand 100 is active and ready to be used. If the wand 100 is being powered by a battery, then a low battery light 112 may be illuminated when the battery needs to be recharged, a new battery installed or the wand 100 should be connected to an external power source. A power button 116 is used to switch the wand 100 on. A conventional battery or a rechargeable battery (e.g., lithium polymer) may be contained within the housing 104 and may be recharged by direct contacts, plug-in cable or inductance. The wand 100 may be environmentally sealed with an IP66 rating.

A lanyard (wrist strap) may be secured to the wand 100 for carrying. A high density polyethylene (HDPE) plastic opening may be used to increase millimeter wave energy sensing if the ABS/PC plastic housing 104 (approx. 0.075″ thick) prevents penetration. A cut-out in the plastic housing 104 may be added and a piece of HDPE can be hermetically bonded to create an environmental seal or a gasket may be used. PCA mounting brackets and plastic bosses are used to secure the electronics within the housing 104.

A background millimeter wave energy value is determined using a moving average as the body is scanned. Thus, when the millimeter wave energy emissions vary by a predetermined range (i.e., anomaly) from the background value based on the moving average, the alarm is activated. Alternatively, prior to beginning a scan of the body, the wand 100 may be reset or zeroed using a reset button 114 on the wand 100 to provide a background millimeter wave energy value of the body based on an absolute value. The wand 100 may generate an audible alarm if any object is detected by the wand 100. This is similar to the current MD wand alarm generation approach. A more advanced approach would take advantage of the multiple detection channels within the millimeter wave energy sensing wand 100. For example, the presence of a proximity sensor in each measurement channel would allow a visual alert (via LEDs) for each measurement element. The audible alarm would sound based on selectable logic (e.g., alarm sounds if an object is detected at any pixel, or, alarm only sounds if M-of-N channels detect an object). Any channel that is not positioned over the body (as might happen when scanning over the arm or leg) would not be capable of generating or contributing to an audible alarm. An audible alarm with individual, channel-based LEDs may simplify the target localization process and speed alarm clearance. LEDs 118 of the millimeter wave sensing wand 100 may also be used to guide the screening process by illuminating the scan area 130 upon scan activation.

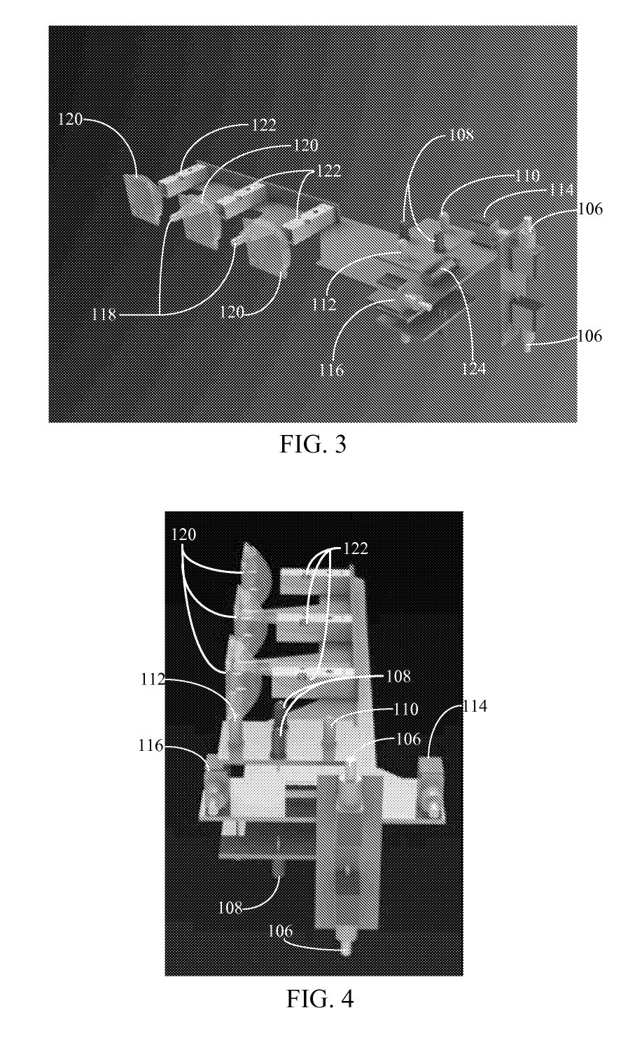

Referring now to FIGS. 3 and 4, the lens(es) 120 of the millimeter wave energy sensing wand 100 ensure rapid scanning of the diverse body part shapes such as the torso, arms and legs, while ensuring gap-free coverage for high probability detection (PD). The size of each lens 120 may be reduced considerably from WBI system lens sizes due to the reduced operating distance. Current WBI systems operate at a nominal 8 ft standoff, while the millimeter wave energy sensing wand 100 may operate at 6 inch standoff or less. This enables a reduction from the current 9 inch lens diameter to ˜0.5 inch diameter, while retaining the same signal-to-noise (S/N) ratio for detection, since range and aperture size are both present in the range equation as squared terms. A nominal 1 inch square lens 120 may be used to provide some detection margin.

In the preferred embodiment, the wand 100 includes three pixels 122 and lenses 120. The pixels 122 are spaced 2.0 inches apart. The lens 120 may be 1.0 to 2.0 inches square and offset 10 to 40 mm from the pixel horn depending on the particular application. The pixel spacing may be 2.0 inches apart. Separate pixels 122 (or modules) may be used for each receive element versus a multi-channel module, and the integration of the lens 120 or MMW antenna into the MMW module. The wand 100 may include a vibration motor 124 that is triggered by the alarm so that the operator can feel or sense when the wand 100 has detected an anomaly in the millimeter wave energy emissions, which may indicate a concealed object on the body.

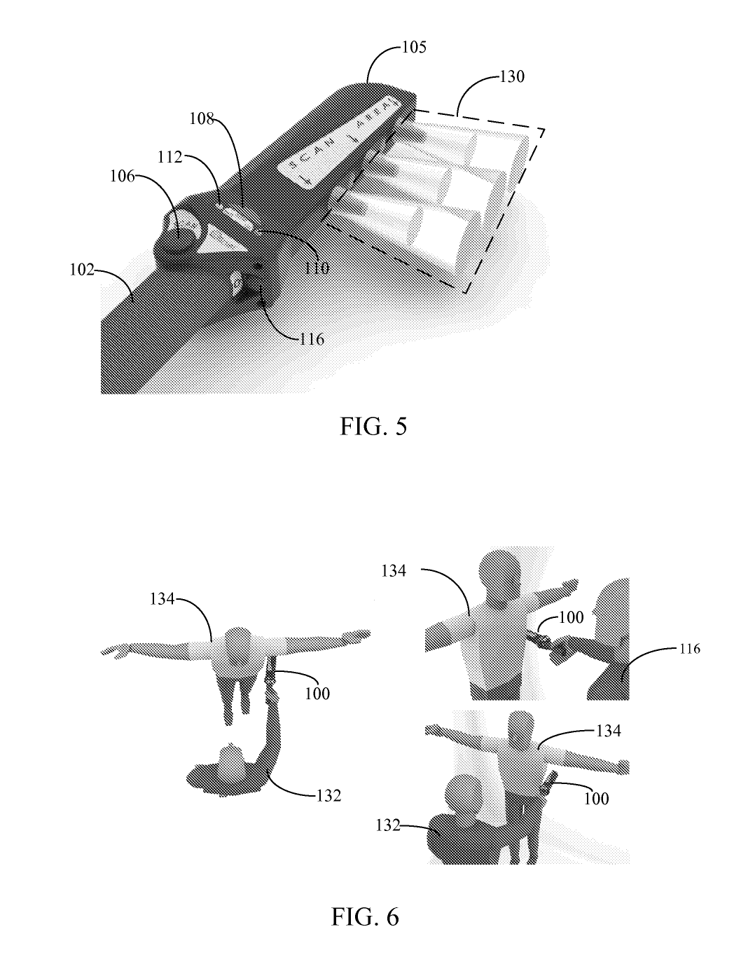

Referring now to FIG. 5, various configurations of the wand 100 are possible to define the scan area 130 with the primary tradeoff being the degree of beam collimation achieved. Cylindrically-shaped beams, which may produce more consistent results over a wider range of standoff distances, require a larger packaging volume (i.e., larger housing) that may complicate scanning between the legs. Conically-shaped beams may reduce the size of the housing, but operation over a tighter standoff range may be required for optimal performance.

The front and back torso of a body 134 are scanned with a U-shaped motion by the operator 132 as illustrated in FIG. 6, while the arms and legs are scanned lengthwise along the top and bottom. The torso scanning requirement drives the length of the multi-pixel aperture, and determines the number of receive elements. An aperture beam extent of ˜9 inches allows torso coverage with a U-shaped scan pattern. The aperture may be a linear array of independent elements. Measurements at each element will be associated with independent detections. A typical scanning approach of a body 134 using the millimeter wave energy sensing wand 100 is estimated to take <1 minute (assuming no alarms). It is important to note that the millimeter wave energy sensing wand 100 does not rely on image-based detection but rather, automated, pixel-level anomaly detection will produce alarms. Therefore, the detection algorithms are substantially simpler than the algorithms operating in the WBI systems. Detection algorithms may alarm off a single-pixel intensity measurement, M-of-N element detections from a single pixel, and/or multiple pixel measurements. The detection algorithms and settings are driven by the size of the threats of interest and the associated false alarm rate for the desired detection performance.

The background millimeter wave energy value may be determined using a moving average and deviations. For example, ten readings and deviations may define a moving average that is stored as a background value. The next reading is received and compared to the background value, which is based on a moving average, to determine whether that next reading is within a standard deviation or an anomaly. If that reading is a statistically significant shift (e.g., not within the standard deviation) and is not characterized by noise, then that reading may be detected as an anomaly and may define an edge of a concealed object. In addition, a quadrupole resonance method may be used to analyze the return values of the millimeter wave energy and if altered, the values (or signature) may be compared to a library of signatures to determine whether a particular type of concealed object may have been detected.

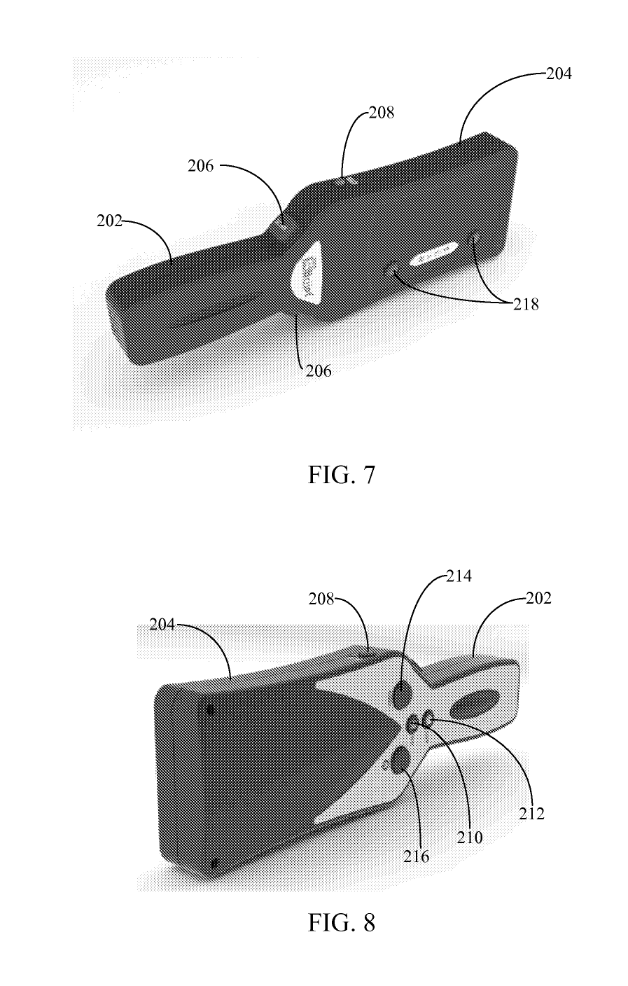

In another particular embodiment and referring now to FIGS. 7 and 8, the millimeter wave energy sensing wand 200 may be configured differently than shown in the preceding figures. For example, the wand 200 has a more traditional metal detector wand shape. The housing 204 is used to contain pixel(s) and other electronic components to detect millimeter wave energy emissions. A handle 202 is configured to be easily grasped by the operator as the wand 200 is passed over a body during scanning. A scan button 206 is located on the shoulder portion of the housing 204 and is used to activate the wand 200 and to begin detecting concealed objects. An alarm light 208 signals the operator visually by turning on and/or flashing when a concealed object may have been located on the body. A power light 210 is disposed on an opposing side of the housing 204 from where the scan LEDs are located. A low battery light 212 indicates when the battery needs to be recharged or a new battery installed. A power button 216 is used to switch the wand 200 on.

Prior to beginning a scan of the body, the wand 200 may be reset or zeroed using a reset button 214 on the wand 200. This provides for the wand 200 to begin processing a moving average or absolute background millimeter wave energy value of the body. Thus, when the millimeter wave energy emissions vary by a predetermined range (i.e., anomaly) from the background value, the alarm is activated. The wand 200 may generate an audible alarm if any object is detected by the wand 200. Any channel that is not positioned over the body would not be capable of generating or contributing to an audible alarm. An audible alarm with individual, channel-based LEDs identify the location of the millimeter wave anomaly on the body. LED illuminators 218 of the millimeter wave sensing wand 200 may also be used to guide the screening process to visually indicate on the body where the millimeter wave emissions indicate a possible threat.

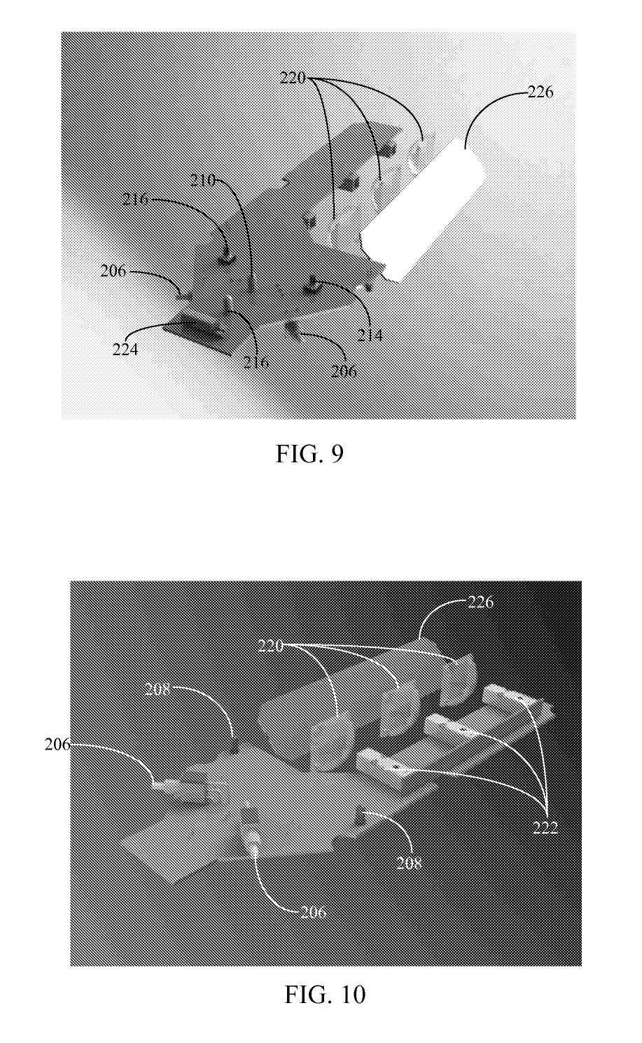

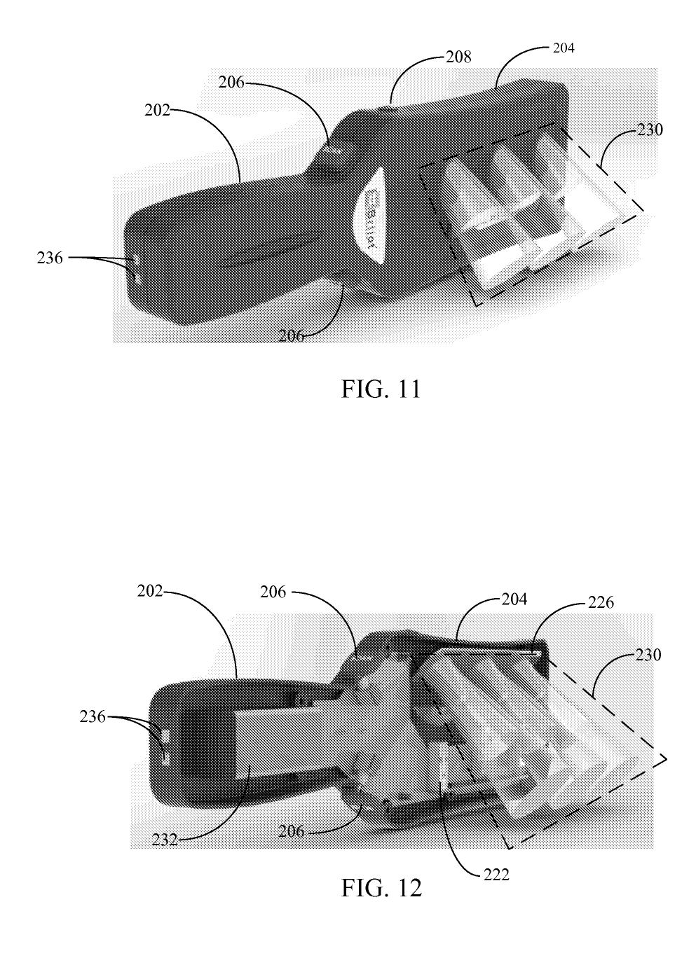

Referring now to FIGS. 9 and 10, a lens 220 is disposed in front of each pixel 222 to focus the millimeter wave emissions. In front of the lenses 220 is an elongated mirror 224 that is used to reflect millimeter wave emissions through the lenses 120. The wand 200 may include a vibration motor 224 that is triggered by the alarm so that the operator can feel or sense when the wand 200 has detected an anomaly in the millimeter wave energy emissions, which may indicate a concealed object on the body.

Referring now to FIGS. 11 and 12, a scan area 230 of the wand 200 is illustrated. The scan area 230 may or may not be perpendicular to the housing face 204 depending on whether the pixels 222 are perpendicular within the housing 204. The width required for the pixels 222, lenses 220 and associated circuitry may require that the pixels 222 be parallel to the housing face 204, which necessitates the mirror 226 to redirect the millimeter wave emissions. A battery 232 may be contained within the handle portion 202 of the wand 200 and can be recharged through direct contacts 236 located on the bottom of the handle 202. Alternatively, the pixels 222 may be perpendicular within the housing 204.

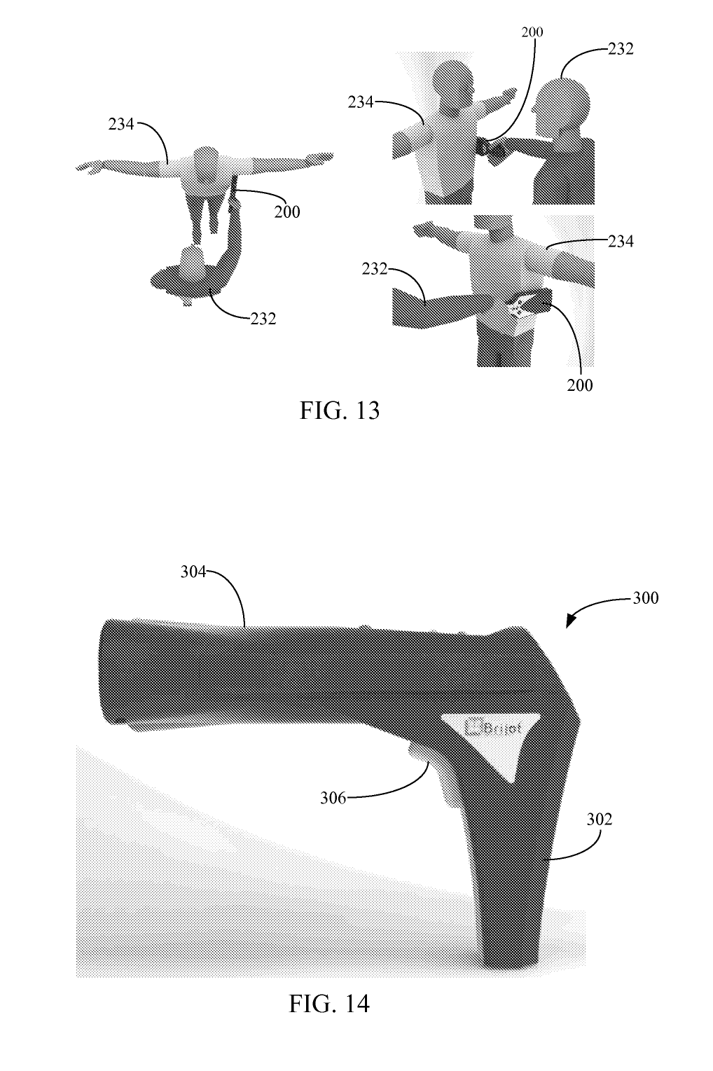

The front and back torso of a body 234 are scanned with a U-shaped motion by the operator 232 as illustrated in FIG. 13, while the arms and legs are scanned lengthwise along the top and bottom. The housing face 204 of the millimeter wave energy sensing wand 200 is moved proximate to the body 234 to detect concealed objects.

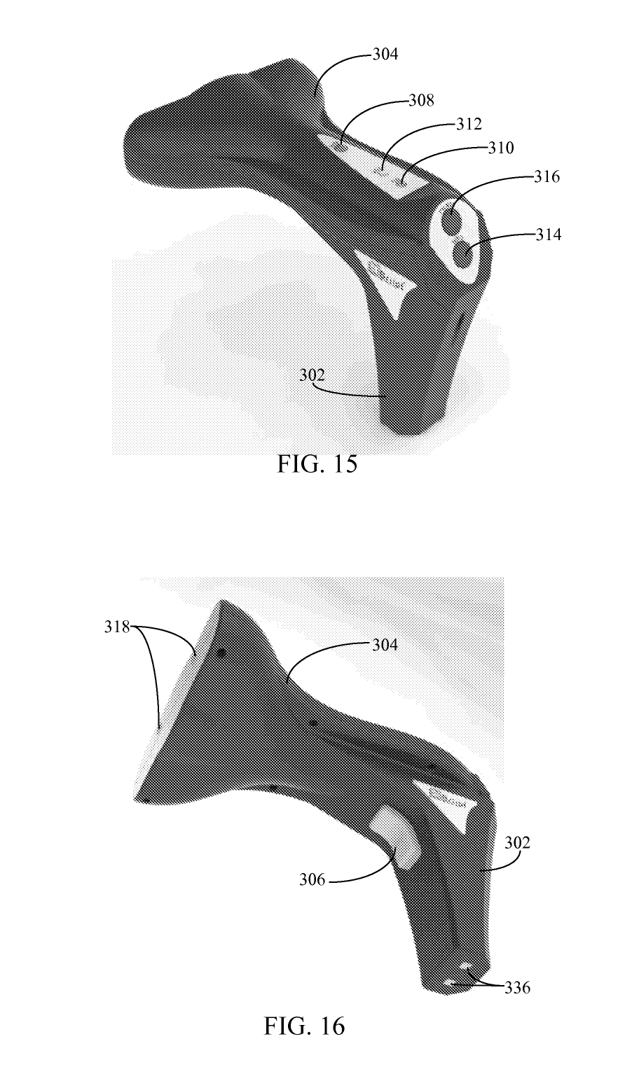

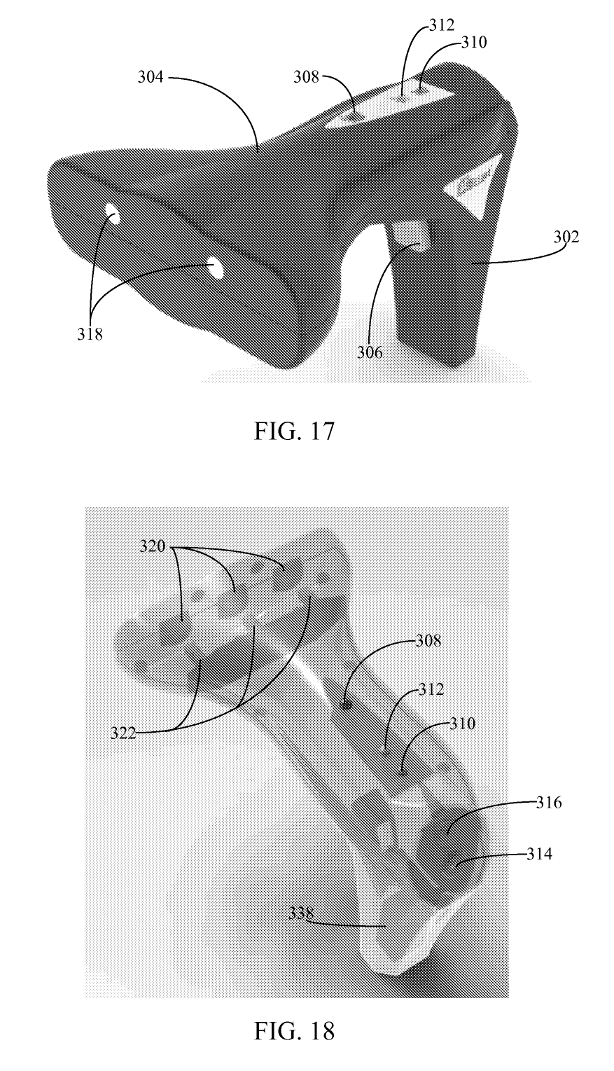

Another particular embodiment is best illustrated in FIGS. 14-17, where the wand 300 has a pistol grip handle 302. The housing 304 is used to contain the pixel(s) and other electronic components to detect millimeter wave energy emissions and the operator points the wand 300 at the desired area of the body to scan. A scan button 306 is located at a trigger location on handle 302 that can be activated with an operator's index finger.

An alarm LED 308, power LED 210, and low battery LED 212 are located on a top portion of the housing 304. A pair of scan LEDs are located on a front portion of the housing 304 and illuminate the scan area 330 upon scan activation. The wand 300 may be zeroed using a reset button 314 on the wand 300 to start a new scan and set a background millimeter wave energy value of the body that may be based on a moving average or absolute value. As explained above, when the millimeter wave energy emissions vary by a predetermined range from the background value, the alarm is activated. The wand 300 may generate an audible alarm if any object is detected by the wand 300.

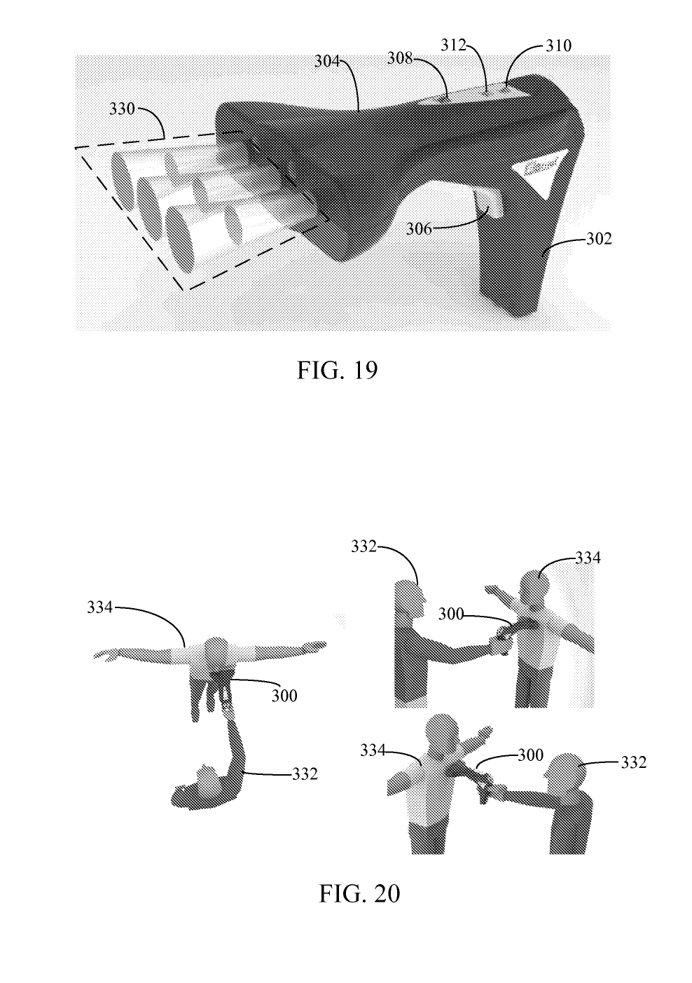

Referring now to FIG. 18, a lens 320 is disposed in front of each pixel 322 to focus the millimeter wave emissions. The wand 300 may include a vibration motor 324 that is triggered by the alarm so that the operator can feel or sense when the wand 300 has detected an anomaly in the millimeter wave energy emissions, which may indicate concealed contraband on the body. A battery 338 may be contained within the handle portion 302 of the wand 300 and can be recharged through direct contacts 336 located on the bottom of the handle 302. The scan area 330 of the wand 300 is illustrated in FIG. 19.

The front and back torso of a body 334 are scanned with a U-shaped motion by the operator 332 as illustrated in FIG. 20, while the arms and legs are scanned lengthwise along the top and bottom. The millimeter wave energy sensing wand 300 is moved proximate to the body 334 to detect concealed objects.

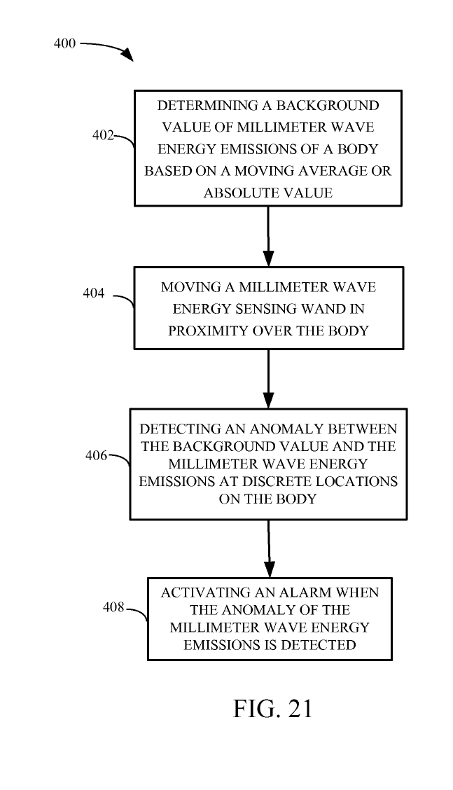

Referring now to FIG. 21, a particular illustrative embodiment of a millimeter wave energy sensing method is disclosed and generally designated 400. A background value of millimeter wave energy emissions of a body is determined, at 402, that may be a moving average value or an absolute value. A millimeter wave energy sensing wand is moved, at 404, in proximity over the body. At 406, an anomaly between the background value and the millimeter wave energy emissions at discrete locations on the body are detected. The anomaly may be detected when a predefined or selected amount of millimeter wave energy appears to be blocked (or reduced to an amount or value) that may indicate a concealed object on the body. An alarm is activated when the anomaly of the millimeter wave energy emissions is detected, at 408.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a digital signal processor, microprocessor, or in any combination thereof. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A millimeter wave energy sensing wand, the method comprising:
a housing adapted to be grasped by a hand of an operator;
at least one pixel contained within the housing, wherein the at least one pixel adapted to detect millimeter or terahertz wave energy emissions; and
an alarm, wherein the alarm is activated when an anomaly of the millimeter or terahertz wave energy emissions is detected.

2. The millimeter wave energy sensing wand of claim 1, further comprising a lens mounted within the housing and configured to focus the millimeter wave energy to the at least one pixel.

3. The millimeter wave energy sensing wand of claim 1, further comprising at least one battery to power the wand.

4. The millimeter wave energy sensing wand of claim 1, further comprising a proximity sensor to determine when the at least one pixel is positioned correctly over a body.

5. The millimeter wave energy sensing wand of claim 1, further comprising light emitting diodes (LEDs) to visually illuminate a scan area on a body.

6. The millimeter wave energy sensing wand of claim 1, further comprising a vibration motor that is activated by the alarm, wherein the vibration motor provides vibrations to a handle portion of the housing.

7. The millimeter wave energy sensing wand of claim 1, further comprising a digital signal processor for processing millimeter wave emissions detected by the at least one pixel to determine millimeter wave energy values.

8. The millimeter wave energy sensing wand of claim 7, further comprising a memory device for storing the millimeter wave energy values.

9. The millimeter wave energy sensing wand of claim 8, further comprising a comparison module for comparing the millimeter wave energy values detected by the at least one pixel to a background millimeter wave energy value.

10. The millimeter wave energy sensing wand of claim 9, further comprising a power switch and scan button disposed on the housing.

11. The millimeter wave energy sensing wand of claim 10, further comprising a reset button to clear the memory device of the background millimeter wave energy value and stored millimeter wave energy values.

12. The millimeter wave energy sensing wand of claim 11, further comprising an alert, power and low battery indicators.

13. The millimeter wave energy sensing wand of claim 12, further comprising external battery contacts for recharging a battery contained within the housing.

14. The millimeter wave energy sensing wand of claim 13, wherein the housing further comprising in part a high density polyethylene (HDPE) plastic.

15. The millimeter wave energy sensing wand of claim 2, wherein the lens is offset from the pixel between 10 and 40 millimeters within the housing.

16. The millimeter wave energy sensing wand of claim 15, further comprising a mirror contained within the housing to reflect millimeter wave energy emissions.

17. A millimeter wave energy sensing method, the method comprising:
determining a background value of millimeter or terahertz wave energy emissions of a body;
moving a millimeter wave energy sensing wand in proximity over the body;
detecting an anomaly between the background value and the millimeter or terahertz wave energy emissions at discrete locations on the body; and
activating an alarm when the anomaly of the millimeter or terahertz wave energy emissions is detected.

18. The millimeter wave energy sensing method of claim 17, further comprising determining when the millimeter wave sensing wand is proximate to the body.

19. The millimeter wave energy sensing method of claim 18, further comprising vibrating the millimeter sensing wand when activating the alarm.

20. The millimeter wave energy sensing method of claim 19, further comprising focusing millimeter or terahertz wave energy emissions to at least one pixel of the millimeter wave energy sensing wand.
